(19) United States
(12) Patent Application Publication
(10) Pub. No.: US 2022/0292006 A1
(43) Pub. Date: Sep. 15, 2022

(54) System for Automatically Generating Insights by Analysing Telemetric Data

(71) Applicant: Vunet Systems Private Limited, Bangalore (IN)

(72) Inventors: Ashwin Kumar Ramachandran, Bangalore (IN); Jithesh Kaveetil, Bangalore (IN); Sagar Saroha, Rohtak (IN)

(21) Appl. No.: 17/690,109

(22) Filed: Mar. 9, 2022

(30) Foreign Application Priority Data
Mar. 9, 2021 (IN) 202141009910
Mar. 9, 2022 (IN) 202244012797

(51) Int. Cl. G06F 11/30; G06F 11/07; G06F 11/34

(52) U.S. Cl. CPC G06F 11/3086; G06F 11/0778; G06F 11/3428; G06F 11/079

(57) ABSTRACT

A system and method for analyzing telemetry of a technology system and generating automated insights are provided. The system receives telemetry from the technology system. The system identifies key metric types in the received telemetry and parses the telemetry. The system categorizes the parsed telemetry and applies domain specific context and rules to the categorized telemetry. The system performs on-demand operations on the categorized telemetry and generates a list of insights based on user preferences. The system generates insightful information comprising human readable text statements, proactive actionable suggestions for preventive measures, predictive forecast of upcoming events, and any combination thereof, for each of the insights. The system creates an output dashboard for the generated insightful information and displays the output dashboard on the user device.

### CROSS-REFERENCE TO RELATED APPLICATION

This application claims priority to and the benefit of the non-provisional patent application titled “System for Automatically Generating Insights by Analyzing Telemetric Data”, application number 202141009910, filed in the Indian Patent Office on Mar. 9, 2022, which claims the benefit of provisional patent application titled “Method and System for Segregation, Analysis and Generation Automated Insights”, application number 202141009910, filed in the Indian Patent Office on Mar. 9, 2021. This application also claims priority to and the benefit of the non-provisional patent application titled “System for Automatically Generating Insights by Analyzing Telemetric Data”, application number 202244012797, filed in the Indian Patent Office on Mar. 9, 2022, which claims the benefit of provisional patent application titled “Method and System for Segregation, Analysis and Generation Automated Insights”, application number 202141009910, filed in the Indian Patent Office on Mar. 9, 2021. The specifications of the above referenced patent applications are incorporated herein by reference in their entirety.

### FIELD OF THE INVENTION

The present invention, in general, relates to a system and a method for analyzing telemetry, in the form of health metrics, performance metrics, logs, trace data, etc., and generating automated insights based on the analyzed telemetry to aid observability, online monitoring, offline monitoring, and development of deeper discernment by guided assistance. The present invention further relates to the generation of both proactive and actionable human readable suggestions based on configurable templates and feature-based segregation of telemetric data.

The present invention further consists of hosting multifarious processing like feature-based segregation, event correlation, root cause analysis, and upcoming behavior forecast via a dashboard interface steered by user preferences. The present invention further contributes to both online and offline monitoring plus operational analysis of the performance of the technology systems. The present invention involves bringing forth composite representation via visualizations, text statement insights, illustrations, and performance indices after feature-based data-analysis.

### BACKGROUND

In the digital era, the sophistication of the backend information technology (IT) systems has grown exponentially. With diverse expansion of digital backbone to newer and newer domains, along with deeper evolution of existing platforms to unprecedented complexities, there is dire need of efficient unconventional mechanisms to monitor and ensure smooth running of underlying IT infrastructure. Revenue flow and sustenance of cyberspace enterprises dealing in E-commerce, Digital payments, Fintech-field dealing, etc., are tied to the fluidic running of abetting IT operations.

Information technology (IT) service firms focus on ensuring satisfactory user experience by focusing on aspects like system availability, quicker system responses, etc. Throughout the entire transaction/task journey, operational metrics aspects need to be maintained at certain optimum levels for uninterrupted user experience. To avoid any sort of unpleasant events like delayed response, network component failure or server downtime, etc., timely identification of potential cause and monitoring of the components is required.

With backend server systems getting complex and user volume rising, the information technology (IT) services are getting more complex than ever. This has led to upsurge in task-load of the IT team monitoring the backend server systems and trying to counter the challenges faced. Many of such potential threats have telemetric signatures in the observable metrics and timely identification can help in quick remedial steps and preventive measures in some cases. But the telemetric data of the IT systems is voluminous and difficult to keep track for timely actionable counter-measures for probable service disruptions.

Furthermore, with the increasing shift of services dependency on digital platforms, the load on the backend server systems handling myriad processes has also risen. Equally increasing is the need for the constant monitoring and analysis of data logs and telemetry to understand the past pattern and ongoing trend of service related behavior. Users require simpler and quicker tools to analyze, process and understand the aforementioned traits from the bulky data logs. Hence, utilizing technological resources for facilitating accelerated and guided analysis of data chunks is the need of the hour. Multitudes of data streams and complex statistical cognizance hidden behind the alphanumeric text logs and metrics need to be unraveled. Identification, analysis and categorical presentations of such connotations and elucidations in simple ways is required to be unveiled from the complex server logs and metrics. This will enable the user to understand the behavioral trends and take timely, adaptive action/decisions as required. Feature based categorization and actionable suggestions related to various metrics will assist users with upkeep in sync to the business drifts.

Furthermore, pictorial and tabular depiction of data using various visualizations tool kits is very common. Such semi-processed representations still ask for human assessment and evaluation to bring out the conclusions and inferences. The human readable statements are prominently obtained through rigorous analysis involving human discretion. Hence there is a need for a system and a method to automatically generate text statement based insights in human readable format.

Numeric ratings and evaluative text comments are common ways of collecting feedback for any product or service. Both are prevalent in many areas, for example, on many e-commerce platforms the end user can submit one's evaluation. In general, adaptation of the product or the service as per the feedback is non-trivial, time taking and an iterative process. It involves extensive human involvement in understanding, drawing inference from the feedback followed by re-designing and almost re-inventing the product or the service. Hence, there is a need for a system with live feedback-based-adaptation.

Hence, there is a long felt need for a system and a method for analyzing telemetry and generating automated insights based on user preferences received from a user device of a user. Furthermore, there is a need for a system and a method to automatically generate text statement based insightful information in human readable format.

### SUMMARY OF THE INVENTION

This summary is provided to introduce a selection of concepts in a simplified form that are further disclosed in the detailed description of the invention. This summary is not intended to determine the scope of the claimed subject matter.

The system and the method disclosed herein address the above recited need for analyzing telemetry and generating a list of automated insights based on user preferences received from a user device of a user. Furthermore, the system and the method disclosed herein comprises a predefined set of examinations of data that have been automated. Furthermore, the system and the method disclosed herein generate text statement based insightful information in human readable format.

The server implemented system comprises a server, data ingestion engine, an insight generation module within a memory of the server, a data store, an insight cards list consolidation module, a user interface layer configured with an application programming interface, and a user device. The server comprises one or more processors, the memory, and the insight generation module. Each of the components in a technology system generates telemetry. The data ingestion engine is configured to collect telemetry of the technology system and send the collected telemetry to the datastore. The data ingestion engine comprises a set of data collectors and a data transformation layer. The set of data collectors are configured to connect to a set of target systems using one or more application programming interfaces (APIs) or similar interfaces. One or more APIs or similar interfaces fetch telemetry from the set of target systems at regular and frequent intervals. The set of target systems comprise databases, web servers, java applications, and network routers. The data transformation layer is configured to receive the telemetry collected by the set of data collectors and perform required data transformations before sending the telemetry to the data store.

The insight generation module is configured to receive the collected telemetry from the data store. The processor of the server is configured to identify key metric type in the received telemetry and parse the telemetry based on the key metric type. The processor is configured to categorize the parsed telemetry based on fundamental characteristics of the telemetry and apply domain specific context and rules to the categorized telemetry. The processor is configured to perform on-demand operations on the categorized telemetry.

The insight cards list consolidation module is configured to generate a list of insights based on user preferences received from the user device of a user. The insight card list consolidation module is configured to categorize information into various genres on the basis of the nature of insights. The insights categories are based on history-data timeline, real-time statistics, string-based queries, data-aggregation, comparative analysis, component health, forecasting, and signal analysis. The insights generation module comprises a rule engine, an extensible domain context engine, a trend analysis module, a root cause analysis module, an anomaly detection module, a forecasting module, and a natural language processing module.

The insight generation module is configured to generate insightful information for each of the insights. The insightful information comprises human readable text statements, proactive actionable suggestions for preventive measures, predictive forecast of upcoming events, and any combination thereof. The generated insightful information provides guided assistance for observability, online monitoring, offline monitoring, and development of deeper discernment. The insights generation module is configured to identify one or more of periodic pattern in spike of load at the server, load on network servers owing to special events, predictive health of computing nodes, component based downtime, low performance components in a network, actionable preventive measures to avoid component failures, decisions related to one or more of upgrading, updating, and amendment of information technology infrastructure, proactive actions which augment readiness for future events handling, performance of commerce centers and banks, contribution proportion of payment to service providers, business volume flow from analysis of said telemetry, and market forecast of product sale and services.

The insight generation module is configured to re-design and regenerate the insightful information, based on one or more of the customization requested by the user and feedback provided by the user. The one or more of said customization requested by the user and the feedback provided by the user is received by the insight generation module from the insight cards list consolidation module via the user interface layer.

The application programming interface of the user interface layer is configured to receive the re-designed and regenerated insightful information from the data store, and create the output dashboard. The user device is configured to receive the created output dashboard from the application programming interface of the user interface layer, and display the received output dashboard on the user device.

The server implemented system is a hybrid version of monitoring and data analysis system, application of which extends to multiple fields dealing with:

1. Digital network data-flow surveillance (and supervision);

2. Online Banking transactions;

3. Server health monitoring;

4. Infrastructure related ticketing system;

5. Challan issue and handling systems;

6. Events correlation;

7. Causal analysis and concurrence prediction; and

8. Forecasting behavioral trends.

Another aspect of the server implemented system is generation of actionable suggestions. This includes recommendations based on data like the network traffic and the server health logs. Even in case of infrastructure related tickets, actions pertinent to tackle a repeated cause are proposed. In case of forecast of product related sales and services, the server implemented system can provide useful inputs regarding preparedness required for business managers. Advice related to possible spikes in sales events can serve as a valuable cue for a priori actions. Causal analysis and ability to detect the occurrence of aberrations equips the server implemented system to suggest remedial measures. Besides stochasticity of events, the server implemented system also provides the corresponding effective maneuvering.

In another embodiment, advance flagging of upsurges is an essential attribute of the proactiveness of the server implemented system. Ability to generate advance notification is significant in multiple ways. For the information technology operations team, advance notification aids in proposing required steps to deal with upcoming load on the system. For management, advance notification serves a timely notice for planning and getting ready for the imminent opportunities. Such information makes timely strategizing and initiation of apposite actions.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein. The description of a method step or a component referenced by a numeral in a drawing is applicable to the description of that method step or component shown by that same numeral in any subsequent drawing herein.

FIG. 1 exemplarily illustrates a server implemented system for analyzing telemetry of a technology system and generating automated insights.

FIG. 2 exemplarily illustrates components of the insight generation module of a server implemented system.

FIG. 3 exemplarily illustrates a table comprising parsed telemetry of an online banking system.

FIG. 4 exemplarily illustrates a table comprising parsed telemetry of an infrastructure monitoring system.

FIG. 5 exemplarily illustrates a table comprising parsed telemetry of a surveillance system and server elements health monitoring system.

FIGS. 6A-6E exemplarily illustrates a first embodiment of an output dashboard displayed on a user device.

FIG. 7 exemplarily illustrates a second embodiment of an output dashboard displayed on a user device.

FIGS. 8A-8B exemplarily illustrates examples of proactive analytics insights and predictive analytics insights.

FIGS. 9A and 9B exemplarily illustrate a method for analyzing telemetry of a technology system and generating automated insights.

### DETAILED DESCRIPTION OF THE INVENTION

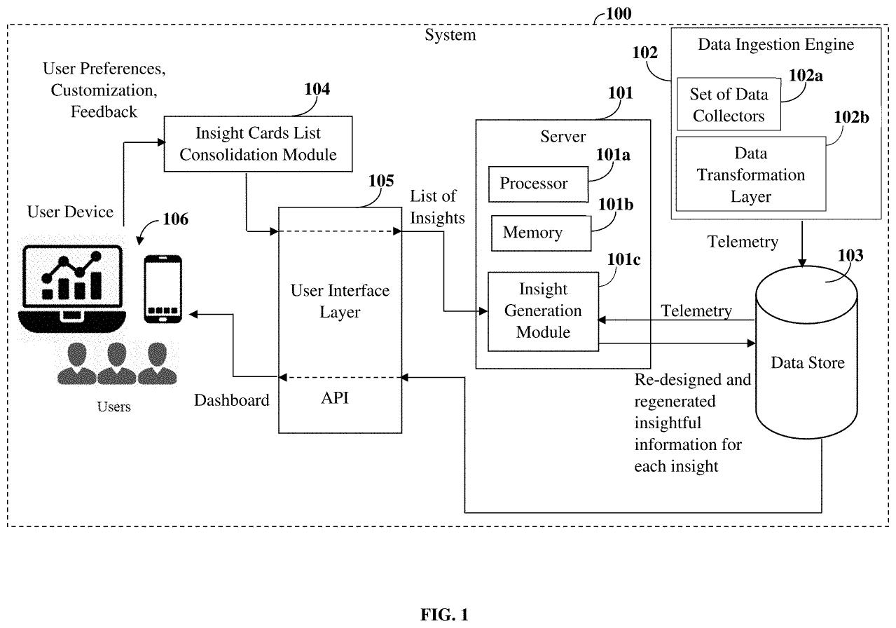

FIG. 1 exemplarily illustrates a server implemented system 100 for analyzing telemetry of a technology system and generating automated insights. The telemetry comprises one or more of health metrics, performance metrics, logs and trace data. The system 100 is implemented as a software platform that can be deployed on-premise or can be deployed as software as a service (SaaS) on cloud. In an embodiment, the system 100 is implemented as a web based platform hosted on a server or a network of servers accessible via a network, for example, the internet, a wireless network, a mobile telecommunication network, etc. In another embodiment, the system 100 is implemented in a cloud computing environment. As used herein, “cloud computing environment” refers to a processing environment comprising configurable computing physical and logical resources, for example, networks, servers, storage, applications, services, etc., and data distributed over a network, for example, the internet. In another embodiment, the system 100 is configured as a cloud computing based platform implemented as a service.

The server implemented system 100 comprises a server 101, data ingestion engine 102, a data store 103, an insight cards list consolidation module 104, a user interface layer 105 configured with an application programming interface, and a user device 106. The server 101 comprises one or more processors 101a, a memory 101b, and an insight generation module 101c. The technology system (not shown) comprises components for example, servers and hypervisors, network components, security devices, load balancers, web servers, application servers, business applications, middlewares, databases, queuing systems, third party application programming interfaces (APIs) and cloud services, etc. The components of the technology system from which telemetry is collected can be residing in an on-premise data center of the enterprise or in a cloud. In case that the components from which telemetry is being collected are in an on-premise data center, the server implemented system 100 can be co-located in the on-premise data center or the server implemented system 100 could be located in the cloud. In both cases, secure connection channels are used to stream telemetry comprising one or more of health metrics, performance metrics, events, logs and trace data of the components of the technology system to the server implemented system 100.

Each of the components in the technology system generates telemetry. Telemetry including logs from the technology system consists of bulks of data containing information about multiple metrics. Depending on the nature of the service and the monitoring application, there are certain data signals which are of prime importance. The data signals can be termed as lead indicators of the objective parameters, for example, turn-around time of the digital payments. These indicators directly influence the user experience and thus data from logs needs segregation on the basis of various operational metrics. Further based on chosen indicators and the features of the data being processed, succeeding operations are planned. As used herein, “service” refers to digital services and online services offered by an enterprise, for example, E-commerce, digital payments, etc., to users using a number of interconnected software and hardware components.

The data ingestion engine 102 is configured to collect telemetry of the technology system and send the collected telemetry to the datastore 103. The data ingestion engine 102 collects large volumes of telemetric data from multiple target systems for analysis. Typically, terabytes of data per day is collected and processed by the systems. The data store 103 provides a long term storage of the telemetric data for consumption by analytics modules like the insight generation module 101c. The data store 103 is designed to scale-up to store terabytes of data with facility to query data for specific time periods and criteria in an efficient way.

The data ingestion engine 102 comprises a set of data collectors 102a and a data transformation layer 102b. The set of data collectors 102a are configured to connect to a set of target systems of the technology system using one or more application programming interfaces (APIs), simple network management protocol (SNMP) polling, open database connectivity (ODBC), syslogs, or similar interfaces. One or more application programming interfaces (APIs), simple network management protocol (SNMP) polling, open database connectivity (ODBC), syslogs, or similar interfaces fetch telemetry from the set of target systems at regular and frequent intervals. The data collectors 102a comprise computer programs which collect the telemetric data from the target systems or servers at regular intervals as log files or data records. The set of target systems comprise databases, web servers, software applications, java applications, firewalls, and network routers.

The data transformation layer 102b is configured to receive the telemetry collected by the set of data collectors 102a and perform required data transformations before sending the telemetry to the data store 103. Data transformation comprises: (a) performing conversions on incoming data, for example, convert time zone of incoming timestamps, do aggregation of system load metrics to calculate average system load, etc., (b) performing enrichments, for example, based on IP address of incoming data, add information about system name, owner and location, etc., (c) performing correlations, for example, combine login and logout events to identify the duration of a user session.

The data transformation layer 102b is configured to breakdown the telemetries into constituting components and dealing with them as per their syntactic roles. Depending on the user work domain, it might require: (i) data conversions like conversion of timestamp values from coordinated universal time (UTC) to Indian standard time (IST) or from local time zones (for global customers) to one common time coordinate; (ii) data aggregation as per the collection frequency. Since the data sending frequency of various data collection agents varies, the data entries need to be combined before storing, for example ‘per 5 minutes’ or ‘per minute’ aggregation; (iii) unification of collected data as per customer requirements, for example, in the case of banking services, data from multiple nodes needs to be unified along with identification of source IP, location, owner, etc; (iv) calculations related to user sessions' data records, for example, for web service, session time is calculated from login time and logout time of users; (v) handling of low quality or missing data, for example, for network health monitoring, missing data values need to be identified and in certain cases noise in the data needs to be smoothed/filtered out, (vi) combining scores from various contributing members for estimating overall health scores, for example, for a family of network components at one server node, the health index of the overall network is calculated from individual components' health index using our aggregation algorithm; (vii) correlation of alert messages. When the threshold value of a certain monitored signal/record entry is crossed, corresponding alert notifications are generated. These alerts are transformed into pre-decided code before passing on to the next stage. Similar response codes and status codes for the behavior of target servers and status of ongoing processes at these target servers are identified and appropriate code is labeled accordingly.

The insight generation module 101c is configured to receive the collected telemetry from the data store 103. The processor 101a of the server 101 is configured to identify key metric type in the received telemetry and parse the telemetry based on the key metric type. The processor 101a is configured to categorize the parsed telemetry based on fundamental characteristics of the telemetry and apply domain specific context and rules to the categorized telemetry. The processor 101a is configured to perform on-demand operations on the categorized telemetry.

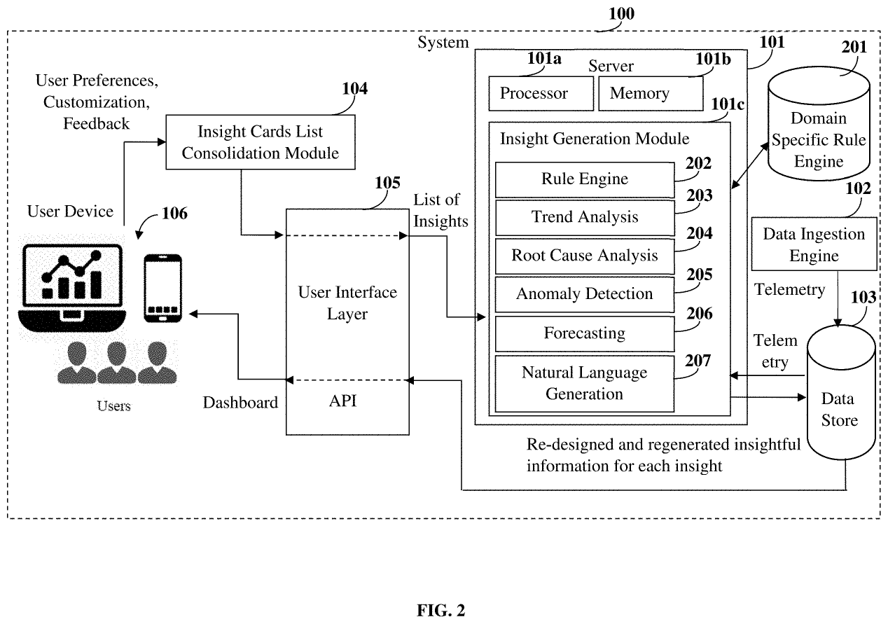

The insight cards list consolidation module 104 is configured to generate a list of insights based on user preferences received from the user device 106 of a user. The insight card list consolidation module 104 is configured to categorize information into various genres on the basis of the nature of insights. The insights categories are based on history-data timeline, real-time statistics, string-based queries, data-aggregation, comparative analysis, component health, forecasting, and signal analysis. The insights generation module comprises 104 a rule engine 202, an extensible domain context engine (not shown), a trend analysis module 203, a root cause analysis module 204, an anomaly detection module 205, a forecasting module 206, and a natural language processing module 207, as exemplarily illustrated in FIG. 2.

The insight generation module 101c is configured to generate insightful information for each of the insights. The insight generation module 101c transforms telemetry at its input into an output comprising the insightful information based on the list of insights provided by the insight cards list consolidation module 104. The insightful information comprises human readable text statements, proactive actionable suggestions for preventive measures, predictive forecast of upcoming events, and any combination thereof. The generated insightful information provides guided assistance for observability, online monitoring, offline monitoring, and development of deeper discernment. The insights generation module 101c is configured to identify one or more of periodic patterns in spike of load at the server, load on network servers owing to special events, predictive health of computing nodes, component based downtime, low performance components in a network, actionable preventive measures to avoid component failures, decisions related to one or more of upgrading, updating, and amendment of information technology infrastructure, proactive actions which augment readiness for future events handling, performance of commerce centers and banks, contribution proportion of payment to service providers, business volume flow from analysis of said telemetry, and market forecast of product sale and services.

The insight generation module 101c is configured to re-design and regenerate the insightful information, based on one or more of the customization requested by the user and feedback provided by the user. The one or more of said customization requested by the user and the feedback provided by the user is received by the insight generation module 101c from the insight cards list consolidation module 104 via the user interface layer 105.

The user interface layer 105 is a software layer that provides facilities through which users of the system 100 can interact with the services provided. The users interact with the system 100 through the user device, for example, desktop computers or laptops or smartphones. In both cases, the user interface layer 105 provides software components to render relevant insights in the user's device 106. The insights would be rendered in the form of English text in insight cards and various other charts. The user interface layer 105 populates these insight cards and charts by fetching relevant data from the backend systems and formatting them as required. The user interface layer 105 provides a set of application programming interfaces (APIs) so that the relevant information as required by the user can be fetched and rendered on the user device 106.

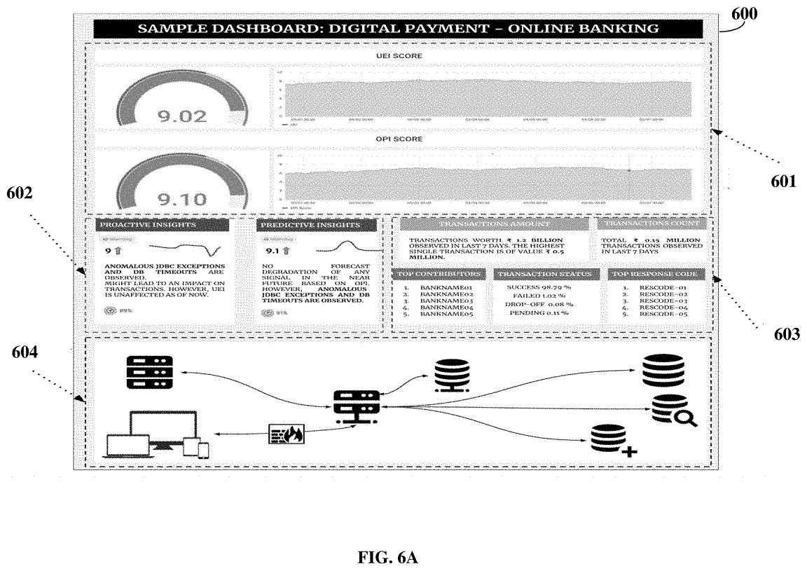

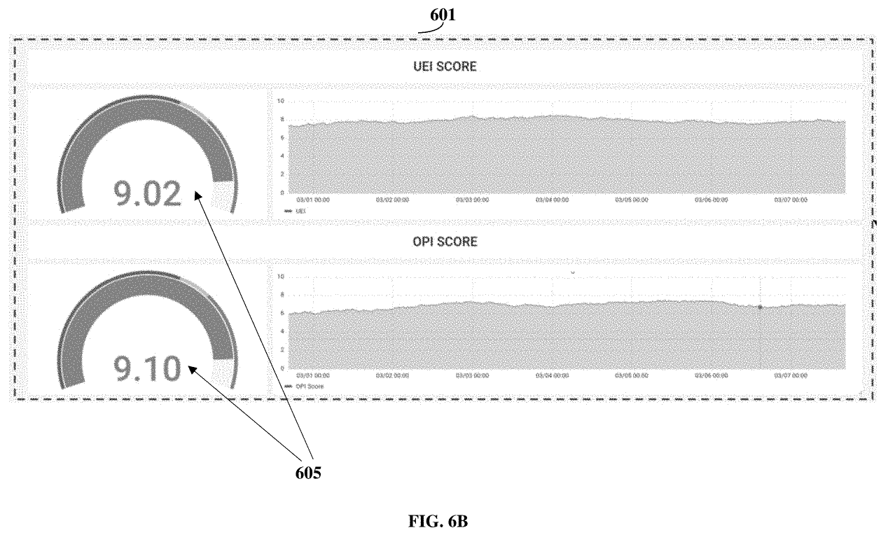

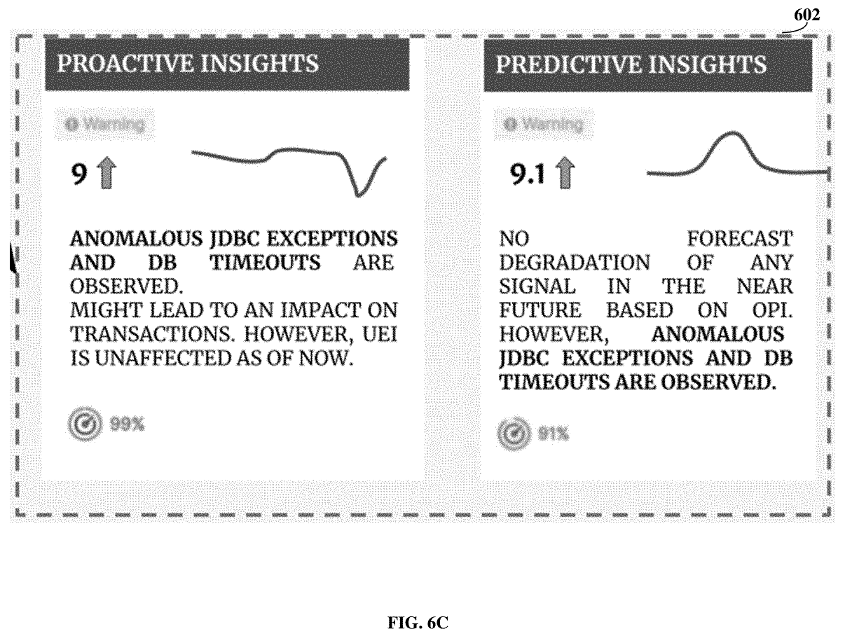

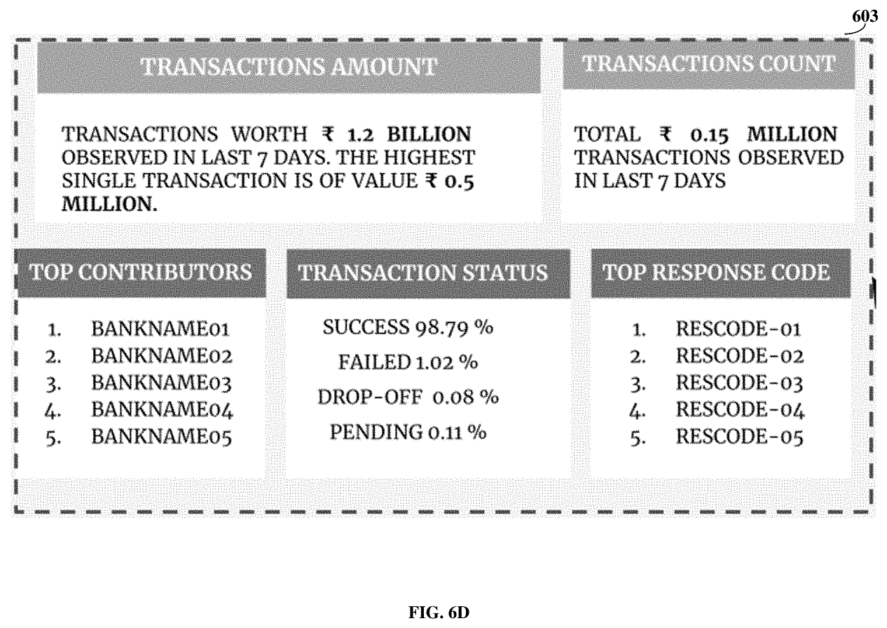

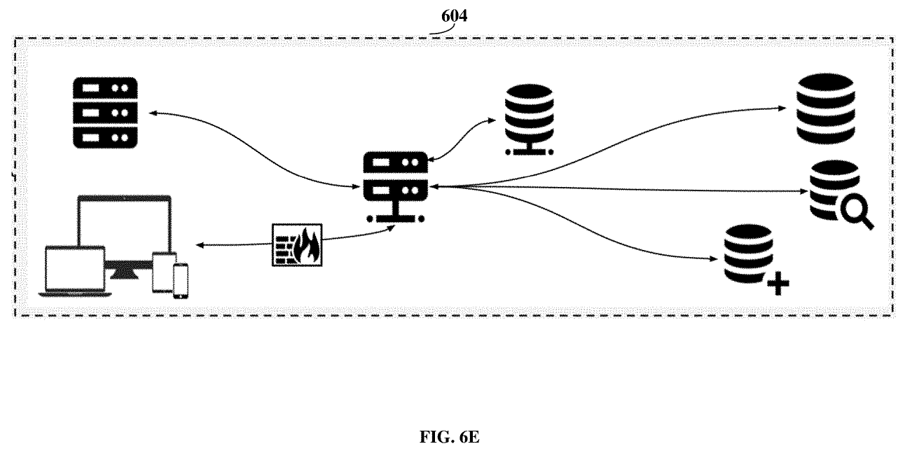

The application programming interface (API) of the user interface layer 105 is configured to receive the re-designed and regenerated insightful information from the data store 103, and create the output dashboard. The API of the user interface layer 105 transforms the re-designed and regenerated insightful information at its input into an output comprising the output dashboard. The user device 106 is configured to receive the created output dashboard from the application programming interface of the user interface layer 105, and display the received output dashboard on the user device 106, as exemplarily illustrated in FIG. 6. The dashboards are a collection of related insights represented using a set of visual elements. For example, a dashboard on an internet banking transaction will consist of insight cards and charts on transaction volume trends, contributors and unusual patterns. The visual elements will consist of insights cards, time series charts and tables.

FIG. 2 exemplarily illustrates components of the insight generation module 101c of a server implemented system 100. The insight generation module 101c runs on the server 101 having one or more processors 101a and a dedicated memory 101b. The insights generation module 101c comprises a rule engine module 202, an extensible domain context engine (not shown), trend analysis module 203, root cause analysis module 204, anomaly detection module 205, forecasting module 206, and natural language generation module 207. The insight generation module 101c has its own dedicated domain specific rule engine 201. The trend analysis module 203 is configured to analyze the telemetric signal for a metric of interest for possible trends or seasonality or similar patterns. The anomaly detection module 205 is configured to perform identification of abnormal behavior of telemetric signals. The root cause analysis module 204 is configured to perform analysis of possible causes of the abnormal behavior of telemetric signals. The forecasting module 206 is configured to predict the future performance of the telemetric signals. The natural language generation module 207 is configured to assist the user in understanding the analysis of the telemetric signals by providing natural language text statements along with other forms of visualizations. Insight generation module 101c receives the collected telemetric data from the data store 103, as described earlier. Re-designed and regenerated insightful information is passed on from the insight generation module 101c to the data store 103.

A non-limiting example of a technology system providing services to end users is, an internet banking system. Internet Banking, also known as net-banking or online banking, is an electronic payment system that enables a customer of a bank or a financial institution to make digital payments or financial transactions or non-financial transactions online via the internet. The internet banking system comprises multiple bank servers to process online payments or online transactions. These bank servers are the source of bulk telemetric data. The bank servers comprise following software components: a) web servers, for example, Nginx, Apache, etc., to handle web service requests from users, b) business applications that provide business functionality are built using various technologies, for example, Java, C++, etc., c) middlewares, for example, IIB, ESB, etc., to interface with core banking systems, d) core banking systems, e) database systems for example, Oracle, MS-SQL, PostgreSQL, etc., f) middlewares to interface with third party systems, interbank networks, etc.

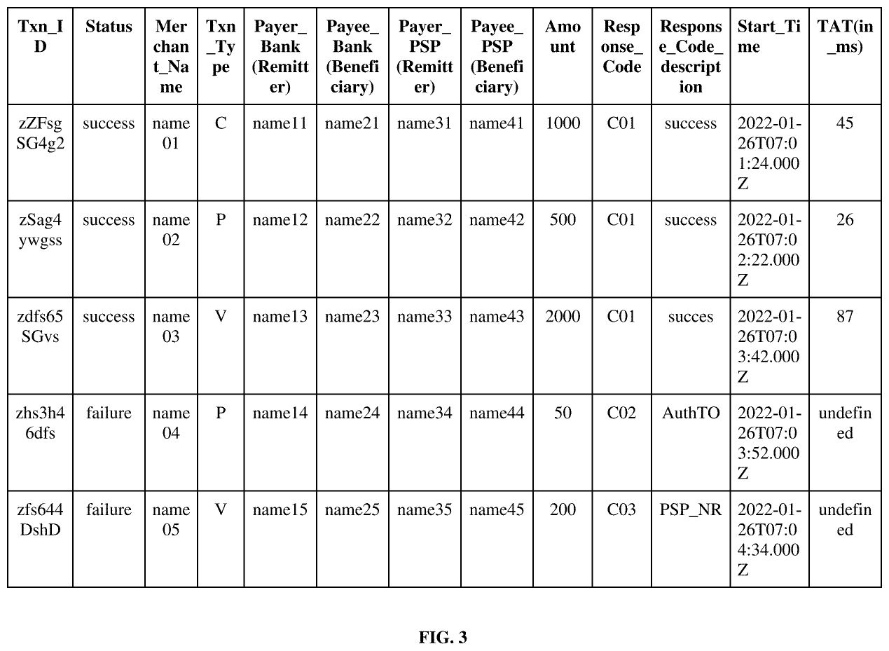

Transaction data, for example, digital payments, financial transactions, non-financial transactions, etc., is collected from the bank servers as a part of data ingestion by the data ingestion engine 102. Multiple data polling agents are employed at the bank server nodes and these data polling agents are automated real-time telemetric-data generating computer programs. The set of data collectors 102a are configured to collect the telemetric data from the multiple data polling agents. The set of data collectors 102a comprise low-latency platforms which can handle real-time feed of the telemetric data at high volume rate. The data transformation layer 102b is configured to parse the collected telemetric data through data transformation layers to unify the telemetric data collected from the multiple data polling agents. This is the pre-processing stage which involves data transformation and altering of the collected telemetric data into required format which is usable for further analysis, for example, data's time zone conversion, data-type conversion, perform aggregations, data filtering, missing data/null value handling, etc. Transformation of data involves the data transformation layer 102b employing parsing tools which identify the data-types and fields based on pre-set algorithms, example of parsed data is shown in FIG. 3.

The data ingestion engine 102 is configured to store the parsed telemetric data in the data store 103. The data store 103 is enabled with multiple features, for example, full-text search capabilities, indexing data in distributed format for faster processing, etc. Even the ‘save and retrieve rate’ of the data store 103 is maintained high to accommodate both high pace of data and high volume of data.

The server implemented system 100 provides templates of sample data visualizations to the user, along with pre-set samples of an entire dashboard. As used herein, “data visualizations” refers to graphical representation of information and data using visual elements like charts, graphs, maps, etc. The user can choose either any of the available template options or customize a new set. The user can perform the customization at any point of time. Parameters/variables that can be of interest for the user are called metrics. For example, ‘total amount of transactions in last 7 days’—here the ‘amount’ is the metric and ‘last 7 days’ is the additional information required to make a meaningful query. For each metric, the user can select the corresponding visualization/output format through unique insight cards via user interface 105 and API requests from the user device 106. The insight cards are metric-specific requests which contain details necessary for generation of insights. For example, ‘total net worth of transactions done on a particular date’, ‘total number of transactions for a week’, etc. These metric-specific requests are a series of selected inputs guided through a set of assisted steps with default options. These default options are already populated with the user interface 105 pertinent to the work domain. The user selections and customizations are passed on ‘Insight cards’ to the insight cards list consolidation module 104.

User preferences and customizations along with feedback for dashboard components are collected as metric based insight-cards. The insight cards list consolidation module 104 receives a bulk request of insight cards and compiles insight cards. The insight cards list consolidation module 104 organizes and transmits a list of insights for various metrics to the insight generation module 101c.

The server 101 interacts with three entities: insight cards list consolidation module 104, the domain specific rule engine 201 and the data store 103. The processor 101a obtains the pre-processed telemetric data from data store 103 and processes the telemetric data based on domain-specific rules and a list of insights cards. The insight generation module 101c is configured to receive the parsed telemetry from the data store 103. The insights generation module 101c is located in a server node 101 with dedicated processor 101a and memory 101b, and the required set of code-modules (not shown).

The processor 101a is configured to segregate the parsed telemetric data based on metric type, for example, transaction volume, monetary value of transactions, status of transactions (as in success, failure, pending, incomplete), name of the banks involved (various banking service providers), response code of transactions (relevant for operations team), etc. The processor 101a is configured to identify these metrics based on the sample data training-identification rules placed in the domain specific rule engine 201. Once identified, then based on the metric type, appropriate operations are performed by the processor 101a based on the rules fetched from domain specific rule engine 201 and the list of insights. For example, in the case of banking transactions: (1) top three contributors ‘merchants’ are identified; (2) total transactions count for a user-selected day; (3) timeline transactions value for the past one month.

The insight generation module 101c, performs multiple operations comprising trend analysis, anomaly detection, root cause analysis, forecasting, root cause analysis and natural language generation. One or more of these operations are performed as per the metric type and the associated provision in the domain specific rule engine 201. For example: (1) summation of the total ‘amount’ of transaction for user-selected past time slot is performed and the same is presented in natural language text statements along with statistical figures; (2) real-time TAT (turn-around-time) statistics for transactions; (3) forecast of transaction ‘amount’ for upcoming ‘month’. After the processing of the insights list and the data, the design and the visualization tools are designed. This generated data is then furthered into the data store 103 as processed information.

The insight generation module 101c is configured to generate insightful information for each of the insights. The insight generation module 101c stores the insightful information, in the data store 103 and from the data store 103 the insightful information is sent to the user dashboard. At this stage, the insightful information contains the metric specific insights which is passed on to the dashboard along with the user's preference of visualization items like table and charts along with human readable text based text insights. The default as well as user-specified rating of the various visualizations is also stored originating from user's feedback and passed on along the data journey through insight cards list consolidation module 104 and the insight generation module 101c.

The user device 106 is configured to receive the created output dashboard from the application programming interface of the user interface layer 105, and display the received output dashboard on the user device 106. The dashboard presents insightful information using various visualization tools along with human-readable texts. It includes information about the past (like history of transactions for last week), present state (active day's data) and actionable suggestions for upcoming events (based on predictions and forecast of future transactions).

Placement of the various graphs, tables, text statements and charts can be rated by the user. This serves as feedback which leads to re-analysis and re-generation of the next iteration of the dashboard adapted accordingly going via path (106→104→105→101→103→106). This feedback based adaptation is realized in real-time making the entire system agile and modular.

A second non-limiting example is infrastructure monitoring of a company/an enterprise. Infrastructure monitoring is the real time data compilation of the systems, processes, and equipment involved in the computing network of the company.

Monitoring overall network health helps information technology (IT) engineers to avoid or mitigate potential network disruptions or downtime. The source of bulk telemetric data are the customer company's network devices and components, which process the operations for the customer. The Network devices and components comprises various access points, network switches, routers, Wi-Fi-devices, local area networks, desktops/laptops, workstations, servers, etc. The data ingestion engine 102 collects network data from all network devices as a part of data ingestion. The network data includes timestamped data about the status of the network interface/network device, source/target internet protocol (IP), incoming/outgoing bandwidth details, device description, device's location, etc. Multiple data polling agents are employed at the customer company's network and these data polling agents are automated real-time telemetric-data generating computer programs.

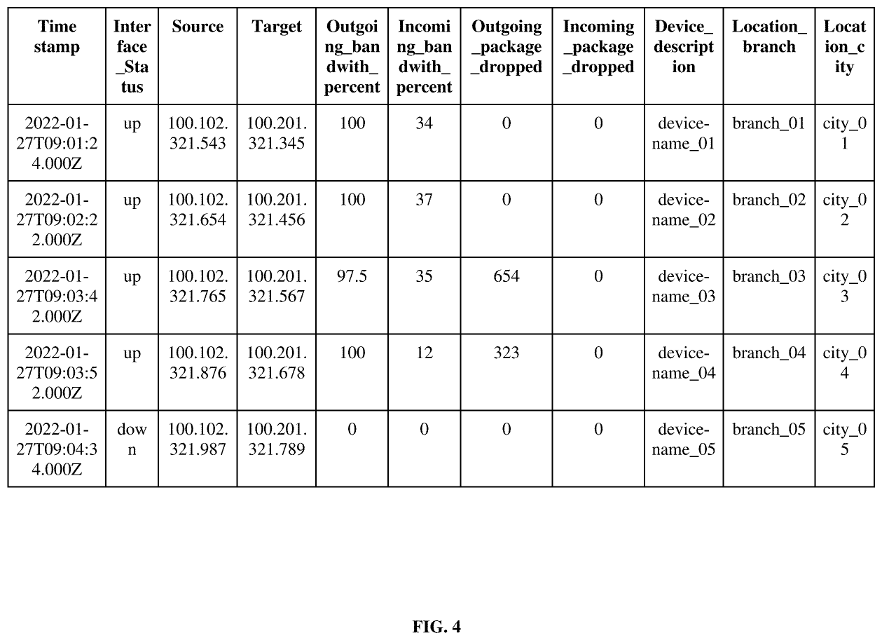

The set of data collectors 102a are configured to collect the telemetric data from the multiple data polling agents. The set of data collectors 102a comprise low-latency platforms which can handle real-time feed of the telemetric data at high volume rate. The data transformation layer 102b is configured to parse the collected telemetric data through data transformation layers to unify the telemetric data collected from the multiple data polling agents. This is the pre-processing stage which involves data transformation and altering of the collected telemetric data into required format which is usable for further analysis, for example, data's time zone conversion, data-type conversion, perform aggregations, data filtering, missing data/null value handling, etc. Transformation of data involves the data transformation layer 102b employing parsing tools which identify the data-types and fields based on pre-set algorithms, example of parsed data is shown in FIG. 4.

The data ingestion engine 102 is configured to store the parsed telemetric data in the data store 103. The data store 103 is enabled with multiple features, for example, full-text search capabilities, indexing data in distributed format for faster processing, etc. Even the ‘save and retrieve rate’ of the data store 103 is maintained high to accommodate both high pace of data and high volume of data.

The server implemented system 100 provides templates of sample data visualizations to the user, along with pre-set samples of an entire dashboard. As used herein, “data visualizations” refers to graphical representation of information and data using visual elements like charts, graphs, maps, etc. The user can choose either any of the available template options or customize a new set. The user can perform the customization at any point of time. Parameters/variables that can be of interest for the user are called metrics. For example, ‘count of over-utilized network devices over last 1 month’: here the ‘bandwidth utilization’ and ‘network device’ are the metrics; ‘high’ and ‘last 1 month’ is the additional information required to make a meaningful query. For each metric, the user can select the corresponding visualization/output format through unique insight cards via user interface 105 and API requests from the user device 106. The insight cards are metric-specific requests which contain details necessary for generation of insights. For example, ‘total number of outgoing packages dropped on a particular date by an interface’, ‘total number of under-utilized devices in the last 3 months’, etc. These metric-specific requests are a series of selected inputs guided through a set of assisted steps with default options. These default options are already populated with the user interface 105 pertinent to the work domain. The user selections and customizations are passed on ‘Insight cards’ to the insight cards list consolidation module 104.

User preferences and customizations along with feedback for dashboard components are collected as metric based insight-cards. The insight cards list consolidation module 104 receives a bulk request of insight cards and compiles insight cards. The insight cards list consolidation module 104 organizes and transmits a list of insights for various metrics to the insight generation module 101c.

The server 101 interacts with three entities: insight cards list consolidation module 104, the domain specific rule engine 201 and the data store 103. The processor 101a obtains the pre-processed telemetric data from data store 103 and processes the telemetric data based on domain-specific rules and a list of insights cards. The insight generation module 101c is configured to receive the parsed telemetry from the data store 103. The insights generation module 101c is located in a server node 101 with dedicated processor 101a and memory 101b, and the required set of code-modules (not shown). The processor 101a is configured to segregate the parsed telemetric data based on metric type, for example, incoming/outgoing bandwidth utilization, packages drop count, status of interfaces/devices (as in up or down), device description, device's location, etc.

The processor 101a is configured to identify these metrics based on the sample data training-identification rules placed in the domain specific rule engine 201. Once identified, then based on the metric type, appropriate operations are performed by the processor 101a based on the rules fetched from domain specific rule engine 201 and the list of insights. For example, (1) top 3 under-utilized interfaces are identified; (2) total bandwidth data for an interface on a user-selected day; (3) timeline of bandwidth utilization for the past one month.

The insight generation module 101c, performs multiple operations comprising trend analysis, anomaly detection, root cause analysis, forecasting, root cause analysis and natural language generation. One or more of these operations are performed as per the metric type and the associated provision in the domain specific rule engine 201. For example: (1) identification of trend of bandwidth load on devices for user-selected past time slot and description of same is presented in natural language text statements along with statistical figures; (2) real-time performance statistics for network interfaces; (3) forecast of ‘utilization’ for upcoming ‘month’ for an interface. After the processing of the insights list and the data, the design and the visualization tools are designed. This generated data is then furthered into the data store 103 as processed information.

The insight generation module 101c is configured to generate insightful information for each of the insights. The insight generation module 101c stores the insightful information in the data store 103 and from the data store 103 the insightful information is sent to the user dashboard. At this stage, the insightful information contains the metric specific insights which is passed on to the dashboard along with the user's preference of visualization items like table and charts along with human readable text based text insights. The default as well as user-specified rating of the various visualizations is also stored originating from user's feedback and passed on along the data journey through insight cards list consolidation module 104 and the insight generation module 101c.

The user device 106 is configured to receive the created output dashboard from the application programming interface of the user interface layer 105, and display the received output dashboard on the user device 106. The dashboard presents insightful information using various visualization tools along with human-readable texts. It includes information about the past (like history of transactions for last week), present state (active day's data) and actionable suggestions for upcoming events (based on predictions and forecast of future transactions).

Placement of the various graphs, tables, text statements and charts can be rated by the user. This serves as feedback which leads to re-analysis and re-generation of the next iteration of the dashboard adapted accordingly going via path (106→104→105→101→103→106). This feedback based adaptation is realized in real-time making the entire system agile and modular.

A third non-limiting example is surveillance system and server elements health monitoring. The source of bulk telemetric data is customer ‘surveillance system and server elements’, which process the business operations. The surveillance system and server elements include various computing devices having processors and memory etc., camera and other sensor based monitoring equipment. The data ingestion engine 102 collects equipment's health data from all such devices as a part of data ingestion. The equipment's health data includes timestamped data about temperature value, memory utilization, central processing usage (CPU) usage, device description, device location, etc. Multiple data polling agents are employed at the customer company's network and these data polling agents are automated real-time telemetric-data generating computer programs.

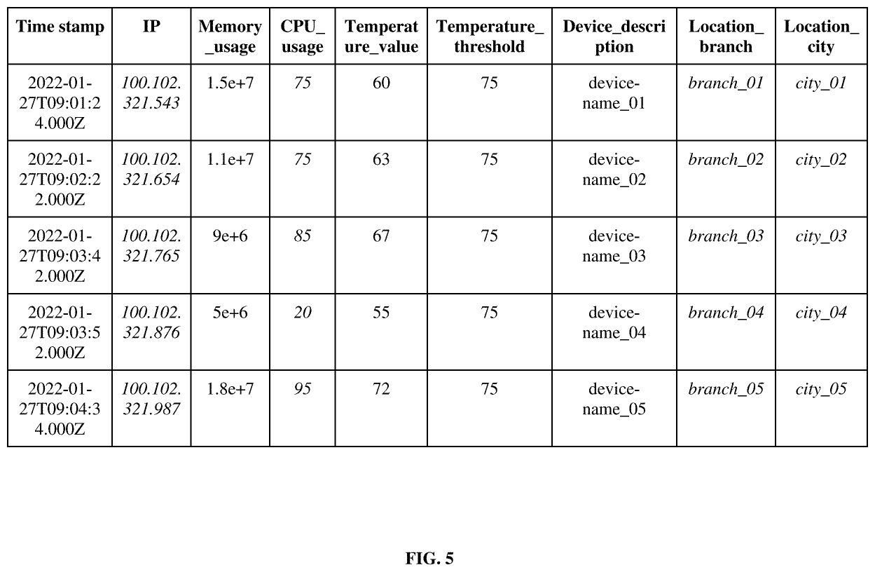

The set of data collectors 102a are configured to collect the telemetric data from the multiple data polling agents. The set of data collectors 102a comprise low-latency platforms which can handle real-time feed of the telemetric data at high volume rate. The data transformation layer 102b is configured to parse the collected telemetric data through data transformation layers to unify the telemetric data collected from the multiple data polling agents. This is the pre-processing stage which involves data transformation and altering of the collected telemetric data into required format which is usable for further analysis, for example, data's time zone conversion, data-type conversion, perform aggregations, data filtering, missing data/null value handling, etc. Transformation of data involves the data transformation layer 102b employing parsing tools which identify the data-types and fields based on pre-set algorithms, example of parsed data is shown in FIG. 5.

The data ingestion engine 102 is configured to store the parsed telemetric data in the data store 103. The data store 103 is enabled with multiple features, for example, full-text search capabilities, indexing data in distributed format for faster processing, etc. Even the ‘save and retrieve rate’ of the data store 103 is maintained high to accommodate both high pace of data and high volume of data.

The server implemented system 100 provides templates of sample data visualizations to the user, along with pre-set samples of an entire dashboard. As used herein, “data visualizations” refers to graphical representation of information and data using visual elements like charts, graphs, maps, etc. The user can choose either any of the available template options or customize a new set. The user can perform the customization at any point of time. Parameters/variables that can be of interest for the user are called metrics. For example, ‘devices with high CPU usage over the last 3 months’: here the ‘CPU usage’ is the metric; ‘high’ and ‘last 3 months’ is the additional information required to make a meaningful query. For each metric, the user can select the corresponding visualization/output format through unique insight cards via user interface 105 and API requests from the user device 106. The insight cards are metric-specific requests which contain details necessary for generation of insights. For example, ‘count of devices with low memory usage in the past 7 days’, ‘count of temperature thresholds of 75 degrees in the last 1 month’, ‘count of camera down in the last 24 hours’, ‘sensors working fine at present’, etc. These metric-specific requests are a series of selected inputs guided through a set of assisted steps with default options. These default options are already populated with the user interface 105 pertinent to the work domain. The user selections and customizations are passed on ‘Insight cards’ to the insight cards list consolidation module 104.

User preferences and customizations along with feedback for dashboard components are collected as metric based insight-cards. The insight cards list consolidation module 104 receives a bulk request of insight cards and compiles insight cards. The insight cards list consolidation module 104 organizes and transmits a list of insights for various metrics to the insight generation module 101c.

The server 101 interacts with three entities: insight cards list consolidation module 104, the domain specific rule engine 201 and the data store 103. The processor 101a obtains the pre-processed telemetric data from data store 103 and processes the telemetric data based on domain-specific rules and a list of insights cards. The insight generation module 101c is configured to receive the parsed telemetry from the data store 103. The insights generation module 101c is located in a server node 101 with dedicated processor 101a and memory 101b, and the required set of code-modules (not shown). The processor 101a is configured to segregate the parsed telemetric data based on metric type, for example, device's IP, device's description, device's location, CPU usage, temperature, memory, etc.

The processor 101a is configured to identify these metrics based on the sample data training-identification rules placed in the domain specific rule engine 201. Once identified, then based on the metric type, appropriate operations are performed by the processor 101a based on the rules fetched from domain specific rule engine 201 and the list of insights. For example, (1) top 3 under-utilized servers are identified; (2) average temperature for an element on a user-selected day; (3) timeline of sensors/camera for the past one month for a said status as ‘up’. The insight generation module 101c, performs multiple operations comprising trend analysis, anomaly detection, root cause analysis, forecasting, root cause analysis and natural language generation. One or more of these operations are performed as per the metric type and the associated provision in the domain specific rule engine 201. For example: (1) identification of trend of CPU and memory usages on devices for user-selected past time slot and description of same is presented in natural language text statements along with statistical figures; (2) real-time performance statistics for cameras/sensors; (3) forecast of future usage load for upcoming ‘month’ for a server. After the processing of the insights list and the data, the design and the visualization tools are designed. This generated data is then furthered into the data store 103 as processed information.

The insight generation module 101c is configured to generate insightful information for each of the insights. The insight generation module 101c stores the insightful information in the data store 103 and from the data store 103 the insightful information is sent to the user dashboard. At this stage, the insightful information contains the metric specific insights which is passed on to the dashboard along with the user's preference of visualization items like table and charts along with human readable text based text insights. The default as well as user-specified rating of the various visualizations is also stored originating from user's feedback and passed on along the data journey through insight cards list consolidation module 104 and the insight generation module 101c.

The user device 106 is configured to receive the created output dashboard from the application programming interface of the user interface layer 105, and display the received output dashboard on the user device 106. The dashboard presents insightful information using various visualization tools along with human-readable texts. It includes information about the past (like history of transactions for last week), present state (active day's data) and actionable suggestions for upcoming events (based on predictions and forecast of future transactions).

Placement of the various graphs, tables, text statements and charts can be rated by the user. This serves as feedback which leads to re-analysis and re-generation of the next iteration of the dashboard adapted accordingly going via path (106→104→105→101→103→106). This feedback based adaptation is realized in real-time making the entire system agile and modular.

FIGS. 6A-6E exemplarily illustrates a first embodiment of an output dashboard displayed on a user device, for example, a desktop. FIG. 6A shows a sample dashboard of ‘Digital Payment: Online Banking’. The tile 601 of the dashboard 600 illustrates performance-index based visualizations, as exemplarily illustrated in FIG. 6B. Digital transactions are handled servers, whose health needs monitoring. User-experience index (UEI) and overall performance index (OPI) are the scoring mechanisms used to determine the health of the servers. On the left of the tile 601, meter gauges 605 depict the present value of the UEI and OPI. On the right of the tile 601, time history for the past 7 days of UEI and OPI is displayed. The second tile 602 of the dashboard 600, contains examples of proactive insights and predictive insights, as exemplarily illustrated in FIG. 6C. Foretelling of anticipated events and projection of possible metric behavior with good confidence levels is possible with the system 100 owing to an ensemble of forecasting algorithms and heuristics. This involves processing of historical data logs and prediction likelihoods. Preemptiveness to awaited trends serves diverse purposes ranging from preventive action on avoiding a bottleneck to identification of the need for upgrading an element of the technology system to meet the expectations for future events. This contributes intrinsic value addition to the robustness of the overall technology systems working. With its help, the system 100 is not only able to meet the present demands, even the forthcoming requirements as well. Proactive actions and suggestions necessitate this feature for holisticity.

The tile 603 of the dashboard 600, presents examples of various human text insights in human readable format. The tile 603 includes statistical insights on transaction's amount, transaction count, top banks contributing to these transactions, percent status of transactions, and the most common five (5) response codes observed, as exemplarily illustrated in FIG. 6D. The tile 604 displays a unified transaction map, which outlays the overall transaction data flow for better understanding and clarity for the user, as exemplarily illustrated in FIG. 6E. The dashboard 600 further contains commonly used visualization tools like charts, tables and graphs (not shown).

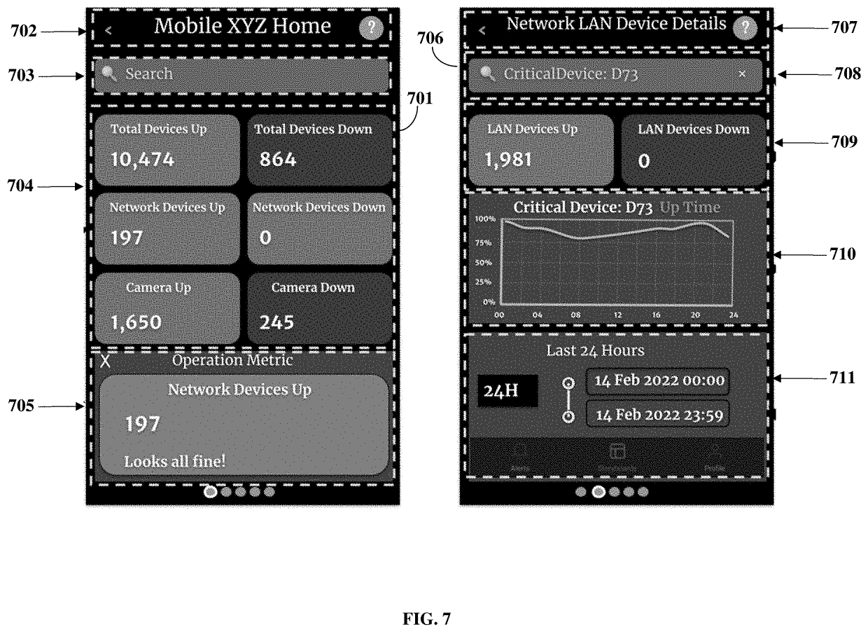

FIG. 7 exemplarily illustrates a second embodiment of an output dashboard displayed on a user device, for example, a mobile, a smartphone, etc. FIG. 7 shows a sample dashboard of network surveillance system and associated server health monitoring components displayed on the user device, for example, a smartphone. The home screen of the mobile application dashboard 701 is shown in FIG. 7. The title 702 with customer name, for example, ‘Mobile XYZ Home’, is positioned on the top of the mobile application dashboard 701, followed by a search bar 703 beneath. The mobile application dashboard 701 comprises a couple of statistical tiles 704 presenting the count of the total number of devices (being Up or Down), followed by network components and cameras. The statistical tiles 704 provide analytics stats of the network Surveillance system. The mobile application dashboard 701 comprises a selected metric tile 705 for ‘network’ components which have ‘up’ status along with a text insight, for example, a pop-up text for chosen variable ‘Looks all fine!’, is shown at the bottom of the mobile application dashboard 701.

The second screenshot displaying details of network local area network (LAN) devices are presented on another page of the mobile dashboard 706. The tile 707 with network detailed analytics, for example, “Network LAN Device Details”, is positioned on the top of the mobile dashboard 706, followed by a search device tile 708, for example, “CriticalDevice: D73”, beneath. The mobile dashboard 706 shows the analytics statistical tiles 709 for the number of LAN devices with ‘up’ and ‘down’ status in selected time windows of the last ‘24 hours’. Below the stat-tiles 709, a ‘history of searched device's status’ tile 710 displaying timeline of count of ‘up’ and running device versus last 24 hours is presented. Below tile 710 is a prompt window 711 to select the active time window. Beneath it, are shortcuts to ‘alerts’ list, new ‘storyboard’ and ‘profile’.

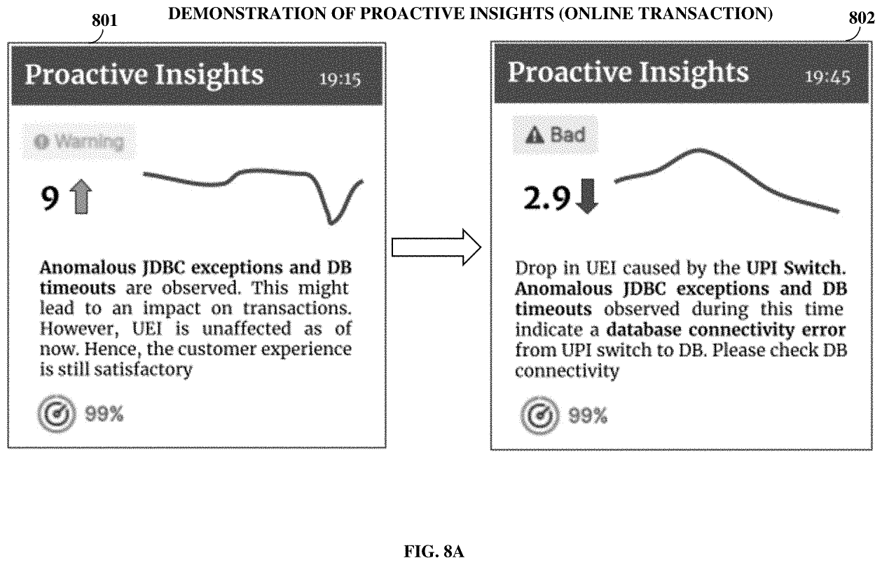

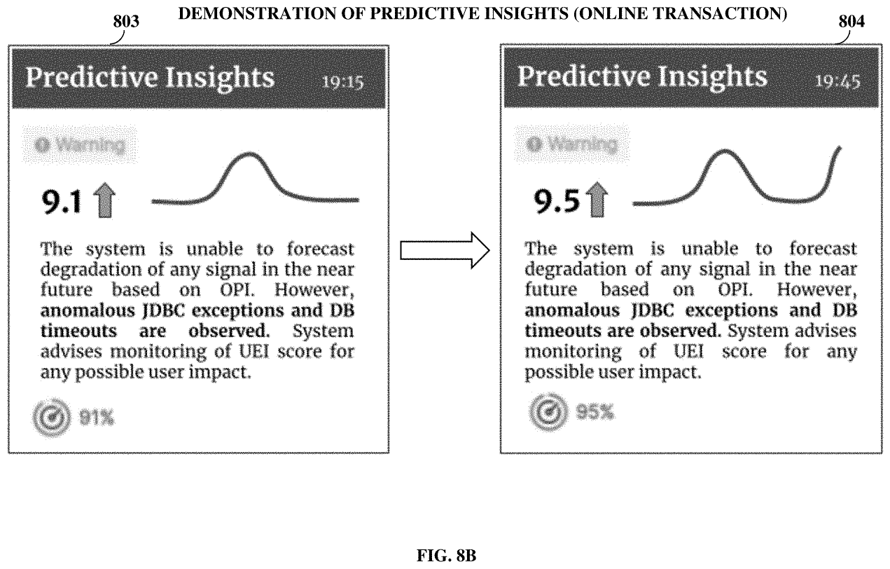

FIGS. 8A-8B exemplarily illustrates examples of proactive analytics insights and predictive analytics insights of an online transaction. Proactive insight tile 801 at 19:15 hours is shown on the left hand side and proactive insight tile 802 at 19:45 hours is shown on the right hand side. In the proactive insight tile 801, we have predictive text mentioning that “Anomalous JDBC exceptions and DB timeouts are observed. This might lead to an impact on transactions. However, UEI is unaffected as of now. Hence, the customer experience is still satisfactory” at 19:15 hours. Predictive analytics of the system 100 senses Java database connectivity (JDBC) exception errors and database (DB) timeouts. The system 100 foretells with 99% confidence that in future it might have an impact on transactions, but at the instant the user experience index (UEI), i.e., the customer, is not affected. As predicted in half an hour, i.e., 19:45 hours, it is observed that “Drop in UEI caused by the UPI Switch. Anomalous JDBC exceptions and DB timeouts observed during this time indicate a database connectivity error from UPI switch to DB. Please check DB connectivity”, as shown in the proactive insight tile 802. Here, the unified payments interface (UPI) faces drop and the expected error did lead to downtime.

Similarly, predictive insight tile 803 reads as “The system is unable to forecast degradation of any signal in the near future based on OPI. However, anomalous JDBC exceptions and DB timeouts are observed. System advises monitoring of UEI score for any possible user impact” at 19:15 hours. Anomaly detection modules sense the abnormal behavior in the overall performance index (OPI) signals and warn about possible upcoming threat of disruption in service with 91% confidence. Eventually in half an hour i.e., at 19:45 hours, predictive insight tile 804 displays “The system is unable to forecast degradation of any signal in the near future based on OPI. However, anomalous JDBC exceptions and DB timeouts are observed. System advises monitoring of UEI score for any possible user impact.” System faces downtime and the degradation of signal hampers the active forecasting.

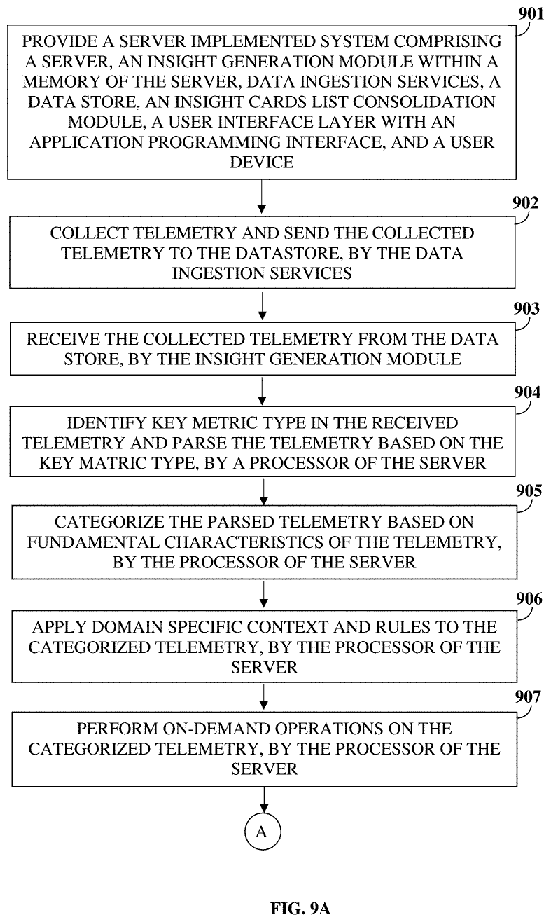

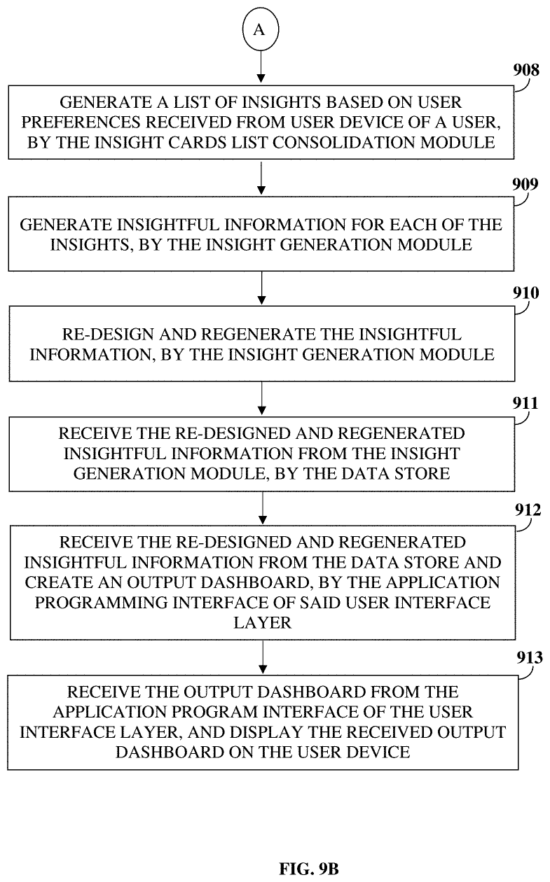

FIGS. 9A and 9B exemplarily illustrate a method for analyzing telemetry of a technology system and generating automated insights. The method comprises providing 901 a server implemented system comprising a server, data ingestion engine, a data store, an insight cards list consolidation module, a user interface layer with an application programming interface, and a user device. The server comprises one or more processors, a memory, an insight generation module resident within the memory. The data ingestion engine collects 902 telemetry and sends the collected telemetry to the datastore. The insight generation module receives 903 the collected telemetry from the data store. The processor of the server identifies 904 key metric types in the received telemetry and parses the telemetry based on the key metric type. The processor categorizes 905 the parsed telemetry based on fundamental characteristics of the telemetry. The processor applies 906 domain specific context and rules to the categorized telemetry. The processor performs 907 on-demand operations on the categorized telemetry. The insight cards list consolidation module generates 908 a list of insights based on user preferences received from the user device. The insight generation module generates 909 insightful information for each of the insights. The insightful information comprises human readable text statements, proactive actionable suggestions for preventive measures, predictive forecast of upcoming events, and any combination thereof.

The insight generation module 910 re-designing and regenerating the insightful information. One or more customization requested by the user and feedback provided by the user. The one or more of the customizations requested by the user and the feedback provided by the user is received by the insight generation module from the insight cards list consolidation module via the user interface layer. The data store receives 911 the re-designed and regenerated insightful information from the insight generation module. The application programming interface of the user interface layer receives 912 the re-designed and regenerated insightful information from the data store and creates an output dashboard. The system receives 913 the output dashboard from the application program interface of the user interface layer, and displays the received output dashboard on the user device.

The system 100 is incorporated with live feedback-based-adaptation, which includes the quick re-analysis, re-processing and customized representation of the output insights and dashboards. Furthermore, the system is incorporated with flexibility to amend or reconstruct as per user demands. This feature is enabled by two characteristics of the system possessing: real-time agile processing and modular generation of insights in conformity of live feedback.

The foregoing examples have been provided merely for explanation and are in no way to be construed as limiting of the server implemented system 100 and the method disclosed herein. While the server implemented system 100 and the method have been described with reference to various embodiments, it is understood that the words, which have been used herein, are words of description and illustration, rather than words of limitation. Furthermore, although the server implemented system 100 and the method have been described herein with reference to particular means, materials, and embodiments, the server implemented system 100 and the method are not intended to be limited to the particulars disclosed herein; rather, the server implemented system 100 and the method extend to all functionally equivalent structures, methods and uses, such as are within the scope of the appended claims. While multiple embodiments are disclosed, it will be understood by those skilled in the art, having the benefit of the teachings of this specification, that the server implemented system 100 and the method disclosed herein are capable of modifications and other embodiments may be effected and changes may be made thereto, without departing from the scope of the server implemented system 100 and the method disclosed herein.

We claim:

1. A server implemented system comprising:
a server comprising:
one or more processors;
a memory;
an insight generation module resident within said memory;
data ingestion engine;
a data store;
an insight cards list consolidation module;
a user interface layer configured with an application programming interface; and
a user device;
said data ingestion engine configured to collect telemetry and send said collected telemetry to said datastore;
said insight generation module configured to receive said collected telemetry from said data store;
said processor of said server configured to identify key metric type in said received telemetry and parsing said telemetry based on said key metric type;
said processor of said server configured to categorize said parsed telemetry based on fundamental characteristics of said telemetry;
said processor of said server configured to apply domain specific context and rules to said categorized telemetry;
said processor of said server configured to perform on-demand operations on said categorized telemetry;
said insight cards list consolidation module configured to generate a list of insights based on user preferences received from said user device of a user;
said insight generation module configured to generate insightful information for each of said insights, wherein said insightful information comprises human readable text statements, proactive actionable suggestions for preventive measures, predictive forecast of upcoming events, and any combination thereof;
said insight generation module configured to re-design and regenerate said insightful information, based on one or more of customization requested by said user and feedback provided by said user, wherein said one or more of said customization requested by said user and said feedback provided by said user is received by said insight generation module from said insight cards list consolidation module via said user interface layer;
said application programming interface of said user interface layer configured to receive said re-designed and regenerated insightful information from said data store, and create said output dashboard; and
said user device configured to receive said created output dashboard from said application programming interface of said user interface layer, and display said received output dashboard on said user device.

2. The system of claim 1, wherein said data ingestion engine comprises:
a set of data collectors, wherein said set of data collectors are configured to connect to a set of target systems using one or more application programming interfaces (APIs) or similar interfaces, wherein said one or more application programming interfaces (APIs) or similar interfaces fetch telemetry from said set of target systems at regular, frequent intervals; and
a data transformation layer, wherein said data transformation layer is configured to receive said telemetry collected by said set of data collectors and perform required data transformations before sending said telemetry to said data store.

3. The system of claim 2, wherein said set of target systems comprise databases, web servers, java applications, and network routers.

4. The system of claim 1, wherein said telemetry comprises one or more of health metrics, performance metrics, logs and trace data.

5. The system of claim 1, wherein said generated insightful information provides guided assistance for observability, online monitoring, offline monitoring, and development of deeper discernment.

6. The system of claim 1, wherein said insights generation module is configured to identify one or more of periodic pattern in spike of load at said server, load on network servers owing to special events, predictive health of computing nodes, component based downtime, low performance components in a network, actionable preventive measures to avoid component failures, decisions related to one or more of upgrading, updating, and amendment of information technology infrastructure, proactive actions which augment readiness for future events handling, performance of commerce centers and banks, contribution proportion of payment to service providers, business volume flow from analysis of said telemetry, and market forecast of product sale and services.

7. The system of claim 1, wherein said insight card list consolidation module is configured to categorize information into various genres on the basis of nature of insights, wherein said insights categories are based on history-data timeline, real-time statistics, string-based queries, data-aggregation, comparative analysis, component health, forecasting, and signal analysis.

8. The system as claimed in claim 1, wherein said insights generation module comprises:
a rule engine;
an extensible domain context engine;
a trend analysis module;
a root cause analysis module;
an anomaly detection module;
a forecasting module; and
a natural language processing module.

9. A method, comprising:
providing a server implemented system comprising:
a server comprising:
one or more processors;
a memory;
an insight generation module resident within said memory;
data ingestion engine;
a data store;
an insight cards list consolidation module;
a user interface layer with an application programming interface; and
a user device;
collecting telemetry and sending said collected telemetry to said datastore, by said data ingestion engine;
receiving said collected telemetry from said data store, by said insight generation module;
identifying key metric type in said received telemetry and parsing said telemetry based on said key metric type, by said processor of said server;
categorizing said parsed telemetry based on fundamental characteristics of said telemetry, by said processor of said server;
applying domain specific context and rules to said categorized telemetry, by said processor of said server;
performing on-demand operations on said categorized telemetry, by said processor of said server;
generating a list of insights based on user preferences received from user device of a user, by said insight cards list consolidation module;
generating insightful information for each of said insights, by said insight generation module, wherein said insightful information comprises human readable text statements, proactive actionable suggestions for preventive measures, predictive forecast of upcoming events, and any combination thereof;
re-designing and regenerating said insightful information, by said insight generation module, based on one or more of customization requested by said user and feedback provided by said user, wherein said one or more of said customization requested by said user and said feedback provided by said user is received by said insight generation module from said insight cards list consolidation module via said user interface layer;
receiving said re-designed and regenerated insightful information from said insight generation module, by said data store;
receiving said re-designed and regenerated insightful information from said data store and creating an output dashboard, by said application programming interface of said user interface layer; and
receiving said output dashboard from said application program interface of said user interface layer, and displaying said received output dashboard on said user device.

10. The method of claim 9, wherein said data ingestion engine comprises:
a set of data collectors, wherein said set of data collectors connect to a set of target systems using one or more application programming interfaces (APIs) or similar interfaces, wherein said one or more application programming interfaces (APIs) or similar interfaces fetch telemetry from said set of target systems at regular, frequent intervals; and
a data transformation layer, wherein said data transformation layer receives said telemetry collected by said data collectors and performs required data transformations before sending said telemetry to said data store.

11. The method of claim 10, wherein said set of target systems comprise databases, web servers, java applications, and network routers.

12. The method of claim 9, wherein said telemetry comprises one or more of health metrics, performance metrics, logs and trace data.

13. The method of claim 9, wherein said generated insightful information provides guided assistance for observability, online monitoring, offline monitoring, and development of deeper discernment.

14. The method of claim 9, wherein said insights generation module identifies one or more of periodic pattern in spike of load at said server, load on network servers owing to special events, predictive health of computing nodes, component based downtime, low performance components in a network, actionable preventive measures to avoid component failures, decisions related to one or more of upgrading, updating, and amendment of information technology infrastructure, proactive actions which augment readiness for future events handling, performance of commerce centers and banks, contribution proportion of payment to service providers, business volume flow from analysis of said telemetry, and market forecast of product sale and services.

15. The method of claim 9, wherein said insight card list consolidation module categorizes information into various genres on the basis of nature of insights, wherein said insights categories are based on history-data timeline, real-time statistics, string-based queries, data-aggregation, comparative analysis, component health, forecasting, and signal analysis.

16. The method of claim 9, wherein said insights generation module comprises:
a rule engine;
an extensible domain context engine;
a trend analysis module;
a root cause analysis module;
an anomaly detection module;
a forecasting module; and
a natural language processing module.
